(19) United States
(12) Patent Application Publication
(10) Pub. No.: US 2004/0208389 A1
(43) Pub. Date: Oct. 21, 2004

(54) Digital picture processing method

(75) Inventor: Wen-Kuo Lin, Taipei (TW)

Correspondence Address: TROXELL LAW OFFICE PLLC, SUITE 1404, 5205 LEESBURG PIKE, FALLS CHURCH, VA, 22041, US

(73) Assignee: SILICON INTEGRATED SYSTEMS CORP.

(21) Appl. No.: 10/413,282

(22) Filed: Apr. 15, 2003

(51) Int. Cl. G06K 9/40

(52) U.S. Cl. 382/260

(57) ABSTRACT

A digital picture processing method for mainly partitioning an inputted picture into a plurality of blocks and then separately performing a deblocking process and a deringing process on each of the blocks so as to reduce the required memory space and to instantaneously process the data.

### BACKGROUND OF THE INVENTION

1. Field of the Invention

This invention relates to a digital picture processing method, and more particularly to a digital picture processing method capable of reducing the required memory space.

2. Description of the Prior Art

Presently, the digital pictures, such as digital still images or digital video frames, have some conventional artefacts, namely blocking artefact and ringing artefact. The blocking artifacts are generated due to the compression performed by block-base compression schemes, such as discrete cosine transform (DCT), and due to the discontinuities at the boundaries of the adjacent blocks caused by the quantization process. The ringing artifacts are generated due to the indistinctions at the object edges caused by discarding high-frequency coefficients during compression.

The above two types of artefacts will degrade the quality of picture, and cause unpleasant viewing experience to the viewer. Therefore, in order to improve the picture quality, a deblocking process and a deringing process are used for removing the block artifacts as well as the ringing artifacts.

Please refer to FIG. 1. FIG. 1 shows the flowcharts of the conventional deblocking and deranging processes. In the step 10, after a picture is inputted, the deblocking process is performed. This deblocking process includes filtering vertical block edges (step 11) and filtering horizontal block edges (step 12). Then, the deringing process is performed. The deranging process includes generating a reference image (step 13) and performing spatial low-pass filtering (step 14). Finally, in step 15, the picture is outputted so as to complete the deblocking and deranging processes.

FIG. 2A is the schematic diagram of the deblocking process in FIG. 1. A picture 2 is partitioned into a plurality of blocks 20, and a boundary between two blocks 20 is defined as a block boundary 200. FIG. 2B is a schematic diagram of enlargement of the dotted region in FIG. 2A. Each of the blocks 20 includes a plurality of pixels 21. In the deblocking process, a vertical or a horizontal low-pass filtering process can be performed to each row of pixels 22 or each column of pixels 23 along the boundary of each of the blocks 20. Therefore, the discontinuity at the boundary 200 of each of the blocks 20 will be smoothed.

FIG. 3A is a schematic diagram of the deringing process in FIG. 1. In the deringing process, a spatial low-pass filtering process is performed to a picture 3 by using a spatial filtering mask 30 so as to smooth the ringing artifacts. However, the spatial low-pass filtering process will make the object edge 300 indistinct. In order to avoid this kind of problem, as shown in FIG. 3B, a binary reference picture 3′ is used for preventing the spatial low-pass filtering process from being applied to the object edge 300′. If the values in a mask window of the picture are the same (for example, a first mask window 31′ and a second mask window 32′), the spatial low-pass filtering process will be used. If the values in a mask window of the picture are not the same (for example, a third mask window 33), the spatial low-pass filtering process will not be used. Because the above method is well-known, no detailed description will given.

FIG. 4 is a perspective diagram of a system for performing the deblocking and deringing processes in FIG. 1. The system comprises a first memory 40, a deblocking module 41 connected to the first memory 40, a deringing module 42 connected to the deblocking module 41, and a second memory 43 connected to the deringing module 42. The first memory 40 is used for inputting a whole piece of picture. The deblocking module 41 includes a filtering processor 410 and a temporary memory buffer 411 for performing filtering function and temporarily storing the data. The deringing module 42 includes a reference map generator 420, a spatial filtering processor 421 and a reference map buffer 422. The reference map generator 420 is used for generating a reference map to the reference map buffer 422, and then the reference map will transmitted to the spatial filtering processor 421 for performing the spatial filtering process on the picture stored in temporary memory buffer411. Finally, the spatial-filrtered picture will be outputted to the second memory 43.

However, the conventional deblocking and deringing processes will cost a lot of time on data processing. This is because in each of the steps, it is required to process a whole piece of picture. Therefore, only after the processing of the whole piece of picture is finished in the previous step, the following step can be performed.

Furthermore, because the processing unit is the whole piece of picture during processing, a greater memory space is required for temporarily storing data. In the prior art, the required memory space is at least double of the space required by the picture. This is because not only the picture but also the reference map data have to be stored. In other words, if a picture is composed of M rows of scanning lines and each of the rows is composed of N pixels, 2×M×N bytes of memory space will be required for storing the inputted picture (source data) and the outputted picture (destination data), and M×N/8 bytes of memory space will be required for storing the reference binary map. Therefore, if the inputted picture in FIG. 4 is composed of M×N bytes, more than 2.125 ×M×N of memory space will be required.

Therefore, the conventional deblocking and deringing processes require greater memory space, and more time is required for data processing. Hence they are not suitable for real-time applications.

### SUMMARY OF THE INVENTION

In order to solve the mentioned problem of the conventional deblocking and deringing processes, this invention provides a digital picture processing method which can process the digital picture more effectively and require less memory space.

The invention relates to a digital picture processing method. In this method, an inputted picture is partitioned into a plurality of blocks, and the deblocking and the deringing processes are performed on each of the blocks so as to reduce the required memory space and to process the data more instantaneously.

In order to achieve the above objective, the digital picture processing method of the invention comprises the following steps. First, a picture to be inputted is partitioned into a plurality of blocks, and the position of each of the blocks is overlapped with the edge of the adjacent block. Next, the deblocking and the deringing processes are performed on each of the blocks. Finally, the processed blocks will be reorganized and outputted so as to complete the deblocking and the deranging processes.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 shows the flowcharts of the conventional deblocking and deringing processes;

FIG. 2A is the schematic diagram of the deblocking process in FIG. 1;

FIG. 2B is a schematic diagram of enlargement of the dotted region in FIG. 2A;

FIG. 3A is a schematic diagram of the deringing process in FIG. 1;

FIG. 3B is a plane schematic diagram of using a binary reference map;

FIG. 4 is a perspective diagram of a system for performing the deblocking and deringing processes in FIG. 1;

FIG. 5 is a flowchart of a preferred embodiment of a digital picture processing method according to the invention;

FIG. 6 is a plane perspective diagram of the picture partitioned into a plurality of blocks in the preferred embodiment;

FIG. 7 is a schematic diagram of the deblocking process in the preferred embodiment; and

FIG. 8 is a perspective diagram of a system performing the digital picture processing method of the invention.

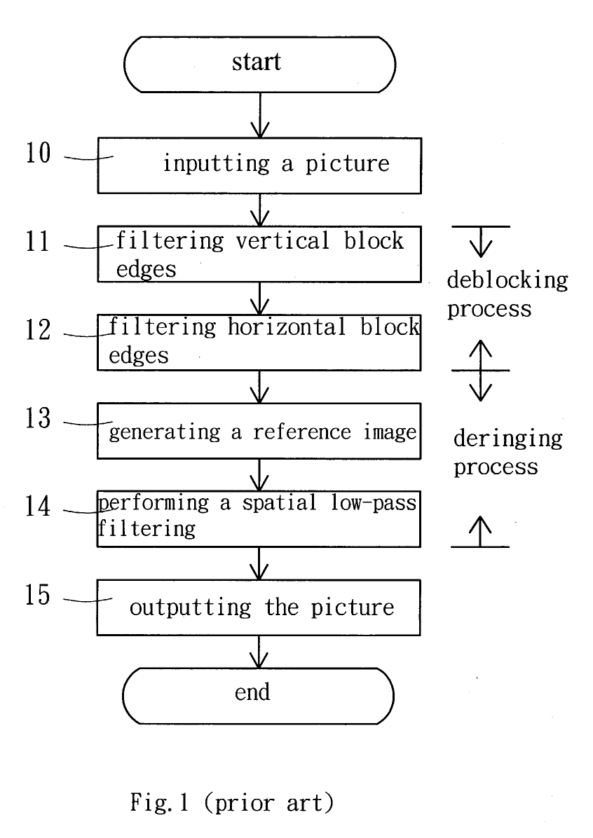

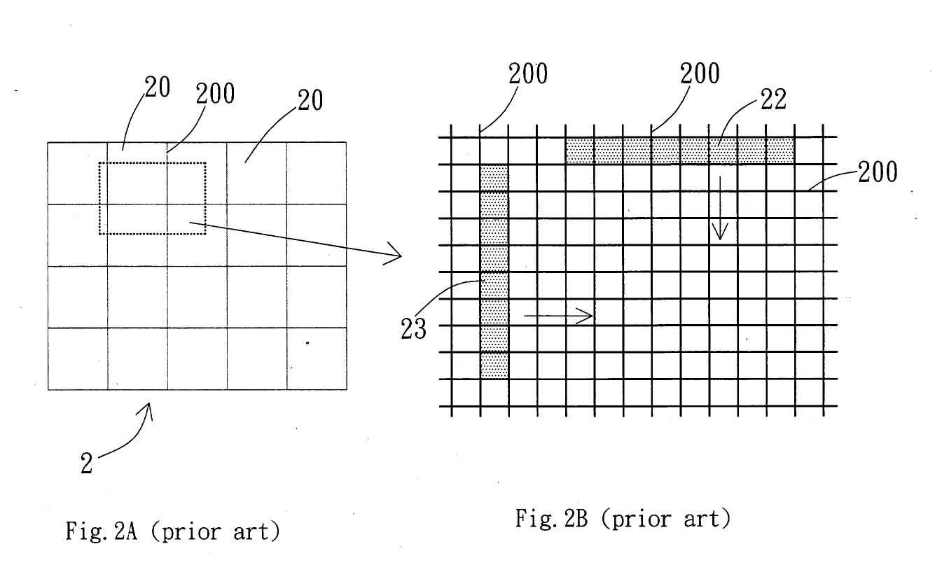

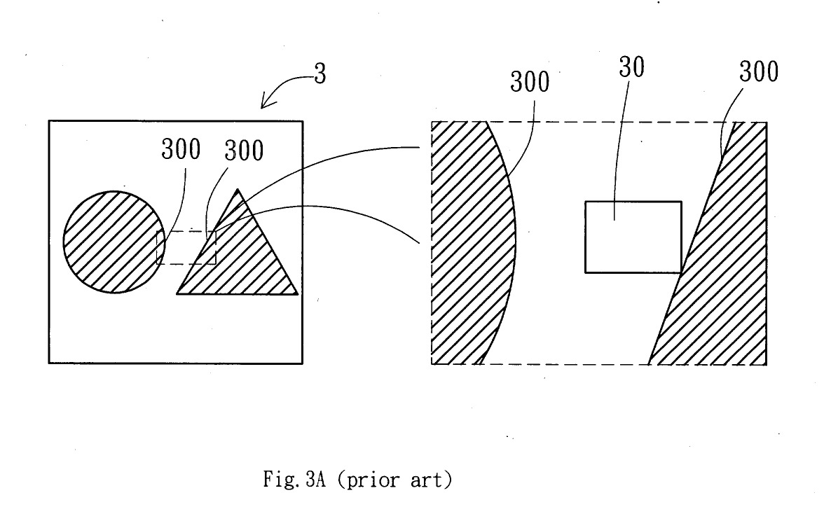

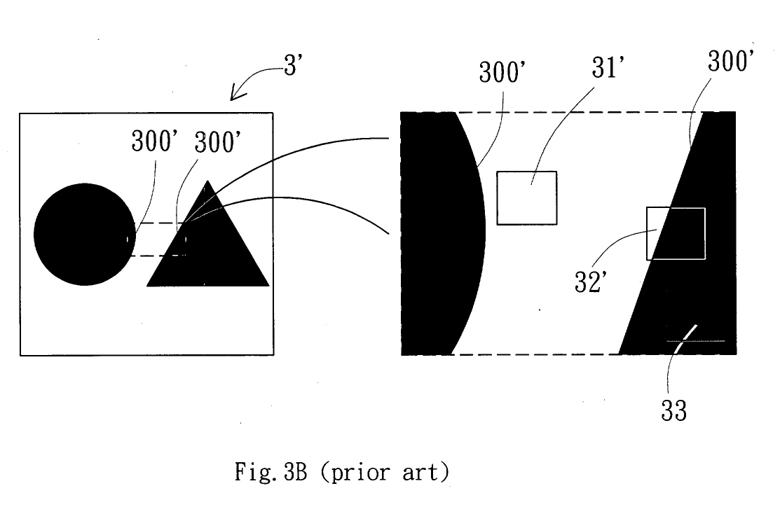

### DETAILED DESCRIPTION OF THE PREFERRED EMBODIMENT

FIG. 5 is a flowchart of a preferred embodiment of a digital picture processing method according to the invention. The method includes the following steps.

First, in step 50, a picture is inputted, and this picture is compressed by using discrete cosine transform (DCT). The picture has a plurality of discrete cosine transformation (DCT) blocks. A block boundary is formed between the DCT blocks. Next, in step 51, this picture is partitioned into a plurality of blocks, and each of the blocks and the edge of the adjacent block are overlapped. In step 52, one of the blocks is inputted into the first memory.

When performing the deblocking process, first, in step 53, the low-pass filtering process is performed on the inputted block along the vertical edge of the DCT block. Then, in step 54, the low-pass filtering process is performed on the inputted block along the horizontal edge of the DCT block.

When performing the deringing process, in step 55, a binary reference map is generated for indicating the object edge. Then, in step 56, the spatial low-pass filtering process is performed so as to remove the ringing artifacts. In step 57, the blocks are outputted to the memory, and in step 58, it is to be determined whether the block is the last block. If yes, then go to step 59 so as to output the picture; If no, return to step 52 so as to input the next block.

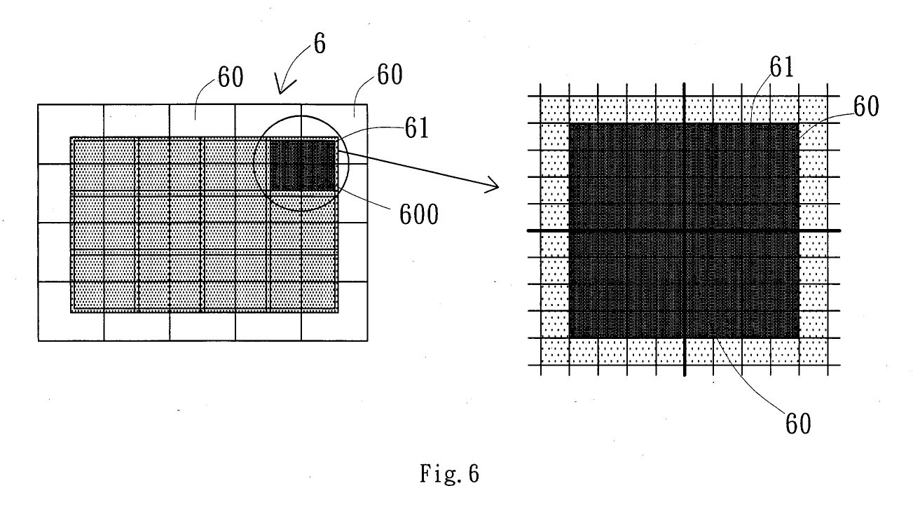

FIG. 6 is a plane perspective diagram of the picture partitioned into a plurality of blocks in the preferred embodiment. The picture 6 is composed of a plurality of DCT blocks 60, and the block 61 is overlapped with the edges of the adjacent block 62, 63 so as to form an overlapping region 610. The blocks in the overlapping region 610 are used as reference. The unoverlapped blocks 611 are the blocks to be processed. For example, in this preferred embodiment, each of the blocks 61 is composed of 10×10 pixels, but only 8×8 pixels are processed.

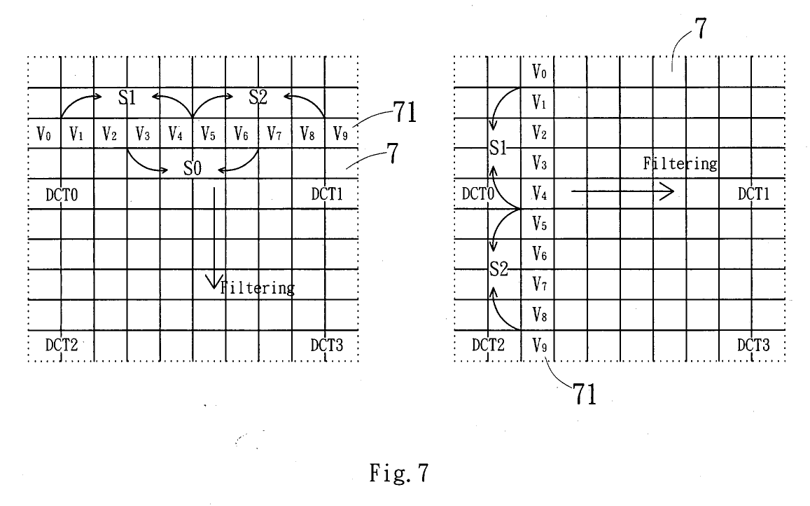

FIG. 7 is a schematic diagram of the deblocking process in the preferred embodiment. Here, v0 to v9 are the coefficients of the vertical pixels 70 of each column or of the horizontal pixels 71 of each row. In FIG. 7, the pixels along the edge 71 of each of the horizontal blocks or along the edge 70 of each of the vertical blocks are scanned. Then. The scanned column (or row) pixels are leaded into a conventional mathematical formula so as to obtain a smoothness coefficient. Therefore, it will be checked that the DCT block is within the smooth region or the non-smooth region. The mathematical formula in this preferred embodiment is as follows:

Thesmoothness

coefficient=φ(v0−v1)+φ(v1−v2)+φ(v2−v3)+φ(v3−v4)+φ(v4−v5)+φ(v5−v6)+φ(v6−v7)+φ(v7−v8)+(v 8−v9)

If |γ|≦THR1, then φ(γ)=1, otherwise φ(γ)=0. And THR1=2.

Next, based on the smoothness coefficient, it will be determined to use a high filtering mode or a low filtering mode. If the value of the smoothness coefficient is greater than a second threshold value (THR2), then the high filtering mode will be used. And if the value is not greater than the second threshold value (THR2), then the low filtering mode will be used. In this embodiment, the second threshold value is 6.

If the high filtering mode is chosen, then the steps of the filtering mode are as follows:

max=MAX(v1,v2,v3,v4,v5,v6,v7,v8),

min=MIN(v1,v2,v3,v4,v5,v6,v7,v8),

If (|max−min|<2QP), then {

$${\sum }_{k = - 4}^{4} {b}_{k} \cdot {p}_{n + k} , 1 \leq n \leq 8$$

$${p}_{m} = \{ \begin{matrix}( \vert {v}_{1} - {v}_{0} ≺ QP \vert ) ? {v}_{0} \text{:} {v}_{1} if m ≺ 1 \\ {v}_{m ,} if 1 \leq m \leq 8 \\ ( \vert {v}_{8} - {v}_{9} ≺ QP \vert ) ? {v}_{9} \text{:} {v}_{8} if m ≻ 8\end{matrix} \}$$

{bₖ:−4≦k≦4}={1,1,2,2,4,2,2,1,1,}//16 }

Otherwise, it will not be changed.

On the other hand, if the low filtering mode is chosen, then perform the following steps:

V₄′=V₄−d,

V₅′=V₅+d,

and d=CLIP(5●(a_{3,0}′−a_{3,0})//8,0(V₄−V₅/2)●δ(|a_{3.0}|<QP)

wherein a_{3.0}′=SIGN( a_{3.0})●MIN(|a_{3.0}|,|a_{3.1}|,|a_{3.2}|),

a_{3.0}=ROUND(([2-55-2]●[V3V4V5V6]T)/8),

a_{3.1}=ROUND(([2-55-2]●[V1V2V3V4]T)/8),

a_{3.2}=ROUND(([2-55-2]●[V5V6V7V8]T)/8),

Because the mathematical formulas in the above steps are well-known in the art and can be well understood by the skilled in the art, the detailed description will not given.

In addition, in the preferred embodiment, the steps of the deringing process are as follows. First, a binary reference map is found out which includes the following steps:

1. First, find out the pixel range and the threshold value (Thr)

Thr=ROUND [(max+min)/2],

Range=max−min

Wherein the max is the maximum value of the pixel, and the min is the minimum value of the pixel.

2. Based on the following cases, the threshold value (Thr) is adjusted.

If (Range<activity th), then Thr=0

Wherein 10<activity th<20

3. Reconstructing the binary reference map

Binmap (u, v)={1 if datasrc (u, v)≧Thr; 0 otherwise

Wherein u,v=0, 1 . . . 9 and datasrc(u,v) is the pixel value after the deblocking process is performed.

Next, by using the binary reference map, a spatial low-pass filtering will be performed so as to avoid filtering out the object edge. In the preferred embodiment, the following steps are included:

All of the binary reference maps in the mask window will be obtained by performing the following mathematical formulas:

$$Counts ( u , v ) = {\sum }_{i = - 1}^{1} {\sum }_{j = - 1}^{1} bin map ( u + i v + j ) ,$$

Wherein u,v=1, 2 . . . 8.

Based on the following cases, the values of all of the binary reference maps in the mask window will be defined as “1” or “0” and the spatial filtering process will be accordingly performed.

If counts (u, v)=0 or counts (u, v)=9, then

$$datast ( u , v ) = {\sum }_{i = - 1}^{1} {\sum }_{j = - 1}^{1} datasrc ( u + i v + j ) \cdot w ( i , j ) ,$$

wherein u,v=1, 2 . . . 8, datast (u, v) is the destination buffer memory and w (u, v) is the spatial filtering mask. In the preferred embodiment, the mathematical formula of the spatial filtering mask is as follows:

$$w ( i , j ) = {\frac{1}{16} }_{[ \begin{matrix}1 & 2 & 1 \\ 2 & 4 & 2 \\ 1 & 2 & 1\end{matrix} ]}$$

Because the mathematical formulas in the above steps are well-known in the art and can be well understood by the skilled in the art, the detailed description will not given.

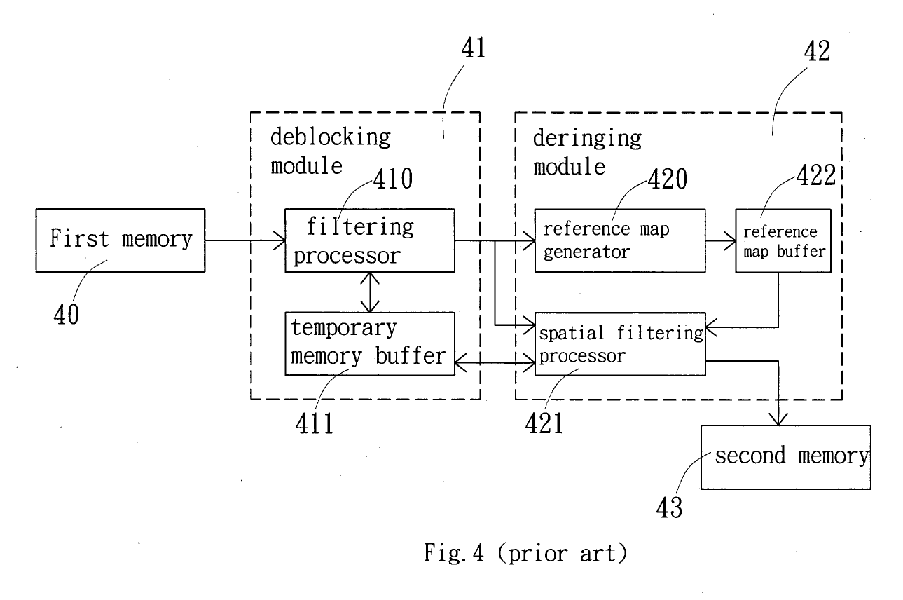

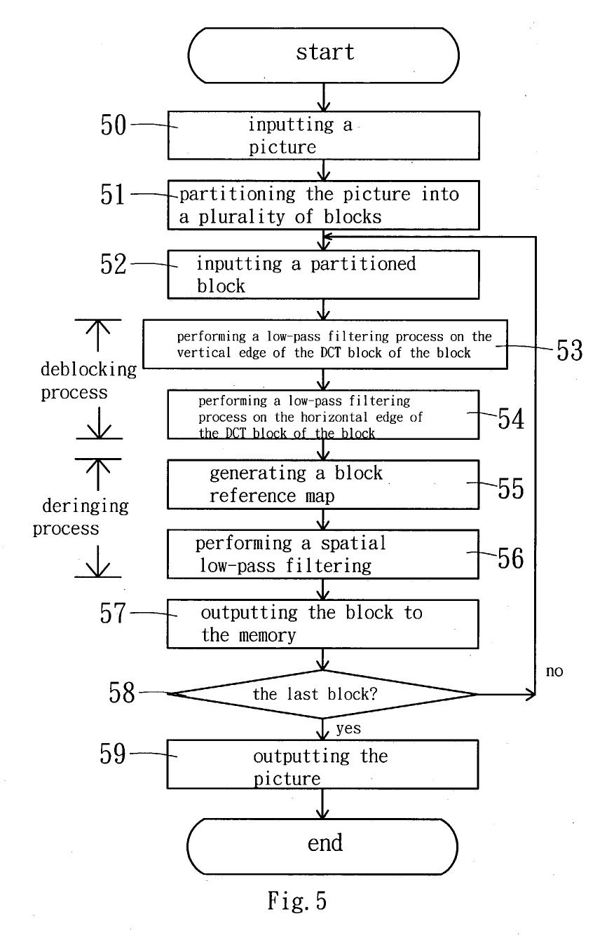

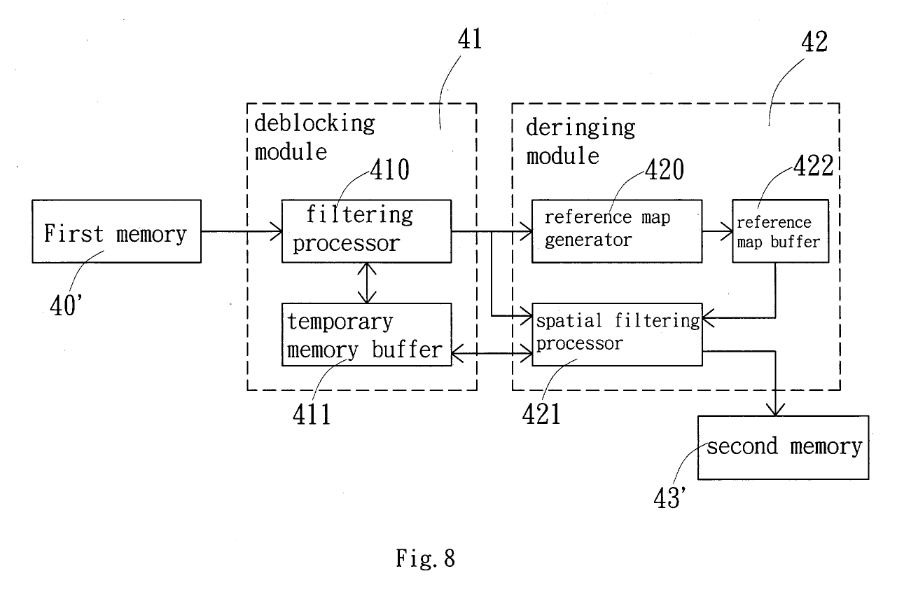

FIG. 8 is a perspective diagram of a system performing the digital picture processing method of the invention. This system also comprises a first memory 40′, a deblocking module 41′ connected to the first memory 40′, a deringing module 42′ connected to the deblocking module 41′, and a second memory 43′ connected to the deringing module 42′, The main difference between this system and the system in FIG. 4 is that only one block is inputted into the first memory body 40′, the temporary memory buffer 411 and the second memory body 43′, in this preferred embodiment, only 10×10 bytes of memory space is required, so that the required memory space is greatly reduced.

What is claimed is:

1. A digital picture processing method, comprising:
partitioning a picture to be inputted into a plurality of blocks;
inputting one of the blocks;
performing a deblocking process;
performing a deringing process;
outputting the block to a memory;
outputting the picture to a second memory after the last block being processed; and
finishing the data processing on the picture.

2. The digital picture processing method of claim 1, wherein the picture comprises a plurality of discrete cosine transformation blocks (DCT blocks), and a block boundary is formed between the DCT blocks; each of the blocks is partially overlapped with the original DCT block.

3. The digital picture processing method of claim 1, wherein the deblocking process comprises the following steps:
performing a low-pass filtering process on the inputted block along the vertical edge of the DCT block; and
performing a low-pass filtering process on the inputted block along the horizontal edge of the DCT block.

4. The digital picture processing method of claim 1, wherein the deringing process further comprises the following steps:
generating a binary reference map indicating the object edge; and
performing a spatial low-pass filtering process.

5. A digital picture processing method, the picture comprising a plurality of discrete cosine transformation blocks (DCT blocks), and a block boundary being formed between the DCT blocks, the method comprising:
partitioning a picture to be inputted into a plurality of blocks, each of the blocks being partially overlapped with the plurality of DCT blocks;
inputting one of the blocks to a first memory;
performing a deblocking process;
performing a deringing process;
outputting the block to a memory;
outputting the picture to a second memory after the last block being processed; and
finishing the data processing on the picture.

6. The digital picture processing method of claim 5, wherein the deblocking process comprises the following steps:
performing a low-pass filtering process on the inputted block along the vertical edge of the DCT block; and
performing a low-pass filtering process on the inputted block along the horizontal edge of the DCT block.

7. The digital picture processing method of claim 5, wherein the deringing process further comprises the following steps:
generating a binary reference map indicating the object edge; and
performing a spatial low-pass filtering process.
